(19) United States
(12) Patent Application Publication
(10) Pub. No.: US 2009/0028564 A1
(43) Pub. Date: Jan. 29, 2009

(54) Dual Broadcast and Narrowcast Systems and Methods

(76) Inventors: Fernando X. Villarruel, Romeoville, IL (US); Timothy J. Brophy, Columbia, MD (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/829,159

(22) Filed: Jul. 27, 2007

(51) Int. Cl. H04J 14/00

(52) U.S. Cl. 398/66

(57) ABSTRACT

Various embodiments of dual broadcast and narrowcast systems and methods are disclosed. One method embodiment, among others, comprises the steps of receiving optical narrowcast signals and converting the optical narrowcast signals to a radio frequency (RF) domain at a first photodiode, receiving optical broadcast signals and converting the optical broadcast signals to the radio frequency (RF) domain at a second photodiode, and combining the RF domain narrowcast and broadcast signals for transmission over a medium.

### TECHNICAL FIELD

The present disclosure is generally related to communications systems, and, more particularly, is related to communication systems comprising broadcast and narrowcast information.

### BACKGROUND

Communication systems come in a variety of forms, with different transport mediums, protocols, and content delivered to a plurality of different devices. Advances in technology have resulted in an evolution within the varied communication systems, often clouding the distinctions between such systems. For instance, in telephony, voice communication has evolved to include the delivery of video and data. Computer networks have evolved to the extent where they are coupled to subscriber television systems for the delivery of multi-media entertainment, including audio and video. Likewise, subscriber television systems offer broadcast signals carrying information broadcast to a wide audience (e.g., content from CBS, NBC, ABC, HBO, etc.) and narrowcast signals carrying context or destination-specific information (e.g., video-on-demand, web-data, etc.). In other words, narrowcast signals are directed more specifically or selectively to individuals or groups of subscribers.

To handle the multitude of information and a burgeoning population of subscribers, various techniques have been implemented to ensure reliable and efficient delivery of information to a wide audience. For instance, in subscriber television systems, among other networks, hybrid fiber/coaxial (HFC) network infrastructures have been developed to create a broadband network to handle a wide range of information. In a subscriber television system utilizing HFC, a forward path (e.g., from a headend to subscribers) carries information through a network of optical and cable mediums and corresponding components and equipment. A return path is also typically established, whereby data from each subscriber terminal (e.g., set-top box) can be carried back to the headend.

Typically, a node is included in the forward path to act as a point of distribution for signals received from the headend, and as a point of consolidation for a plurality of subscriber terminals sending signals back to the headend. Nodes may be “partitioned” logically to segment the node into a plurality of subgroups, each subgroup responsible for feeding information to and receiving information from a plurality of subscriber terminals. For instance, narrowcast signals, given the selectivity in intended destinations, are often demultiplexed at the node, and channeled to the logical segment to be forwarded to the intended destination.

Several techniques have been employed in the past to provide narrowcast and broadcast signals over an optical network. One method involves the use of a broadcast transmitter residing at the headend to deliver broadcast signals and a plurality of narrowcast transmitters multiplexed at the headend to deliver narrowcast signals. The broadcast transmitter can be an externally modulated or directly modulated optical transmitter located at or near the dispersion point of the optical fiber. The narrowcast transmitters generally comprise high launch powers (e.g., >8 dBm) and utilize a dense wave division multiplexed (DWDM) ITU spectrum in the “C” band to reduce nonlinear crosstalk due to high launch powers. The broadcast and narrowcast signals are carried along the optical medium and received at a receiver residing at the node, the receiver combining the broadcast and narrowcast signals. The receiver generally comprises a photodiode that receives and converts the optical signal to an electrical signal for further processing.

Some limitations to such a conventional approach include the use of the DWDM spectrum in which the launch powers are high, which may increase the risk of non-linear cross-talk at large wavelength differences. Another limitation with this and other conventional systems is the limited bandwidth (e.g., 100 MHz) that can be realized while maintaining industry-grade standards. Other limitations found in conventional systems include the high cost involved in maintaining or upgrading the performance. For instance, a broadcast transmitter in the above-described architecture, particularly for distances greater than 30 kilometers (km), or for transmitter launch powers exceeding approximately 15 dBm, uses external modulation (as opposed to direct modulation). Further, DWDM narrowcast transmitters in an ITU grid implies a laser wavelength stabilization cost and the cost associated with using a higher power level.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an exemplary subscriber television system in which embodiments of dual broadcast and narrowcast (DBN) systems can be implemented.

FIG. 2 is a schematic diagram of an embodiment of a DBN system implemented in the subscriber television system shown in FIG. 1.

FIG. 3 is a schematic diagram of an embodiment of a receiver system of the DBN system shown in FIG. 2.

FIG. 4 is a schematic diagram of an alternate embodiment of a receiver system of the DBN system shown in FIG. 2.

FIG. 5 is a flow diagram of an embodiment of a DBN method implemented by the DBN system shown in FIG. 2.

FIG. 6 is a flow diagram of an embodiment of a DBN method implemented by the DBN system shown in FIG. 2.

### DETAILED DESCRIPTION OF THE PREFERRED EMBODIMENTS

Disclosed herein are various embodiments of dual broadcast and narrowcast (DBN) systems and methods. In one embodiment, a DBN system comprises separate and distinct receiver photodiodes configured to receive and convert optical broadcast and narrowcast signals, respectively, to the radio frequency (RF) domain. For instance, in one embodiment, a first photodiode is configured to receive and convert optical narrowcast signals transmitted from one or more narrowcast transmitters, and a second photodiode is configured to receive and convert optical broadcast signals transmitted from one or more broadcast transmitters. The first and second photodiodes can be co-located in the same receiver module (e.g., housed in the same enclosure) in some implementations and in separate receiver modules in other implementations. After conversion, the RF domain signals from the first and second photodiodes are then combined. It should be appreciated that the use of a first and second photodiode in the example above is for illustration, and that one having ordinary skill in the art should understand in the context of this disclosure that additional photodiodes may be employed in one or more receiver modules in some embodiments. By receiving broadcast and narrowcast transmissions in separate photodiodes, various cost and performance benefits accrue to the entire system in which the DBN system is implemented, as explained further below.

For purposes of the description that follows, a “broadcast” transmission generally refers to a transmission of signals carrying information (e.g., audio, video, and/or data) to all receivers, or transmitted in an omnidirectional pattern. Broadcast transmissions are commonly equated to, though not limited to, transmissions that can be received over the airways by a device equipped with an antenna (e.g., network TV, such as NBC, ABC, etc.). A “narrowcast” transmission, on the other hand, generally refers to transmission of signals carrying information directed or targeted to a specific or limited group of receivers. For instance, narrowcast transmissions are often associated with the delivery of services (e.g., video-on-demand, Internet links) to limited locations and/or for a limited time, though not necessarily limited to these constraints. In some implementations, narrowcast transmissions can be defined geographically (e.g., a physical neighborhood, region, etc.) and/or contextually or logically (e.g., on a service basis, such as a cyber (or Internet) basis), either of which comprise boundaries that may change over time.

Various embodiments of DBN systems and methods are described below in the context of a subscriber television system, with the understanding that other data delivery systems are considered to be within the scope of the disclosure.

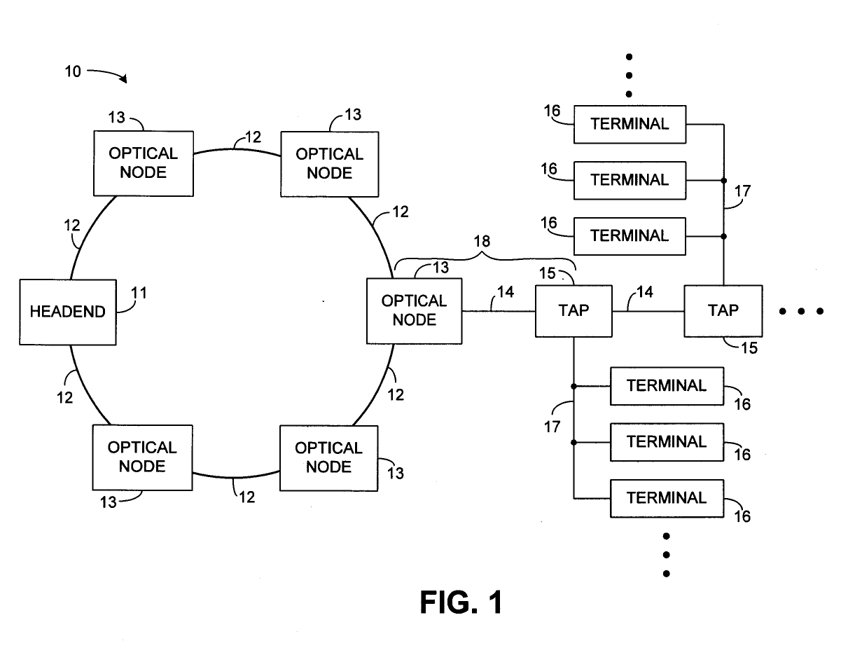

FIG. 1 is a block diagram of an exemplary subscriber television system 10 including a headend 11 for receiving television signals (e.g., satellite television signals, etc.) and other data (Internet data, etc.) from external providers or other sources, and converting the signals into a format for transmitting the signals over the system 10. The transmitted signals among optical nodes 13 comprise optical signals transmitted over fiber optic cable 12. That is, when the optical signals are transmitted by the headend 11, one or more optical nodes 13 are included in the system 10 for converting the optical signals to RF signals that are thereafter routed over other media, such as coaxial cables 14. Taps 15 are provided within the system 10 for splitting RF signals off, via cables 17, to subscriber terminals 16 such as set-top terminals configured as stand-alone devices or embodied in cable-ready television sets, video recorders, or computers. Thus, the headend 11 is connected through a network 18 to multiple subscriber terminals 16.

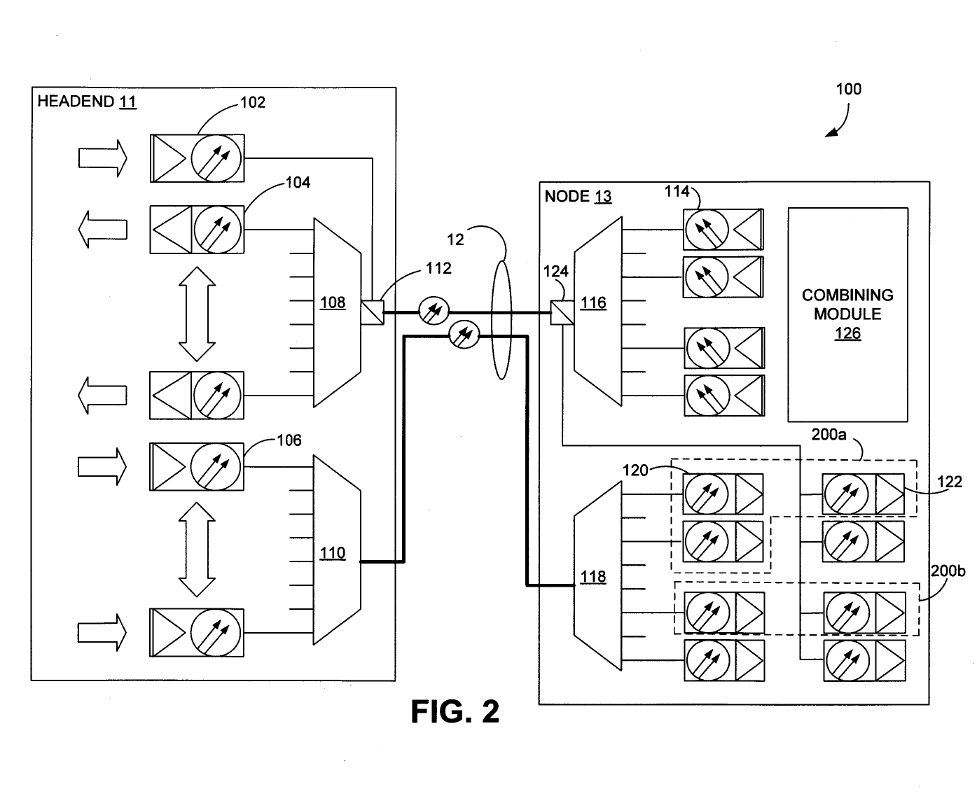

FIG. 2 is a schematic diagram of an embodiment of a DBN system 100 implemented in the subscriber television system 10 shown in FIG. 1. In one embodiment, the DBN system 100 comprises a headend 11 and an optical node 13 coupled over one or more optical fibers. The headend 11 comprises one or more broadcast transmitters 102, one or more receivers 104, and one or more narrowcast transmitters 106. In one embodiment, the broadcast transmitter 102 is directly modulated. A direct modulated transmitter may offer certain cost benefits relative to externally modulated transmitters. The broadcast transmitter 102 may utilize coarse or dense wave division multiplexing (CWDM or DWDM). In some embodiments, the broadcast transmitter 102 can be externally modulated, with different range and/or power specifications. Since broadcast transmitters are known in the art, further discussion of the same is omitted for brevity.

The narrowcast transmitters 106, in one embodiment, are directly modulated. By reducing the maximum launch power, the cost of the narrowcast transmitter 106 can be significantly reduced. The headend 11 also includes one or more demultiplexers 108 coupled to the receivers 104, one or more multiplexers 110 coupled to the narrowcast transmitters 106, and one or more filters 112 coupled to the broadcast transmitter. Since narrowcast transmitters are known in the art, further discussion of the same is omitted for brevity.

One having ordinary skill in the art should understand that other components, not shown in FIG. 2, may also reside in the headend 11, including various content servers, modulators (e.g., QAM), combiners, encoding devices, control modules, among other hardware and/or software components for the delivery of content to a plurality of subscribers.

In operation, the broadcast transmitter 102 receives a broadcast RF signal from an RF source, and converts the RF signal to an optical signal according to mechanisms known in the art. The broadcast transmitter 102 then feeds (e.g., via laser) the optical signal to the filter 112, which separates the bands (e.g., 1310 and 1550 nanometer (nm) bands) before propagation over the optical fiber 12. The narrowcast transmitters 106 receive narrowcast signals, convert the signals to the optical domain, and feed the optical signals to the multiplexer 110. In one implementation, the multiplexed channels include 1471 nm through 1611 nm, inclusive (e.g., eight wavelengths), though not limited to such specifications. The multiplexed channels are then fed to the optical fiber 12, hence carrying the narrowcast signals to one or more downstream locations.

Although shown as two separate optical fibers dedicated to broadcast and narrowcast information, respectively, in some embodiments, the broadcast and narrowcast information signals may be carried along a single optical fiber, or along a greater number of optical fibers.

For reasons to be explained below, the use of separate photodiodes at the receiving end of the optical fiber 12 enables reduced power operation of the narrowcast transmitters 106. The reduced power of the narrowcast transmitters 106, compared to transmitter powers of conventional systems, enables operation in a coarse wavelength division multiplexing (CWDM) spectrum (e.g., ITU G.694.2), as opposed to the DWDM spectrum often employed in conventional systems, without loss (or without significant loss) of signal quality usually posed by higher power CWDM systems (e.g., susceptibility to non-linear Raman gain penalty). Further, by changing the WDM spectrum from DWDM to CWDM, the wavelength stabilization of the laser in each narrowcast transmitter 106 is no longer needed (or is only partially needed). Additionally, the cost of cooling the laser of the transmitter is virtually eliminated, since the laser is allowed to drift within the large CWDM passband. For instance, in some embodiments, passive stabilization may be employed (e.g., using cooling fins), which generally is a lower cost cooling method than the methods employed in conventional systems (e.g., active cooling).

The optical node 13 comprises one or more transmitters 114 coupled to one or more multiplexers 116. The multiplexer 116 multiplexes the return data fed by the transmitters 114 for delivery to the headend 11. In particular, the return data is carried over the optical fiber 12 and demultiplexed at the demultiplexer 108, which feeds the demultiplexed channels to receivers 104. The node 13 also includes a demultiplexer 118, one or more narrowcast receivers 120 coupled to the demultiplexer 118, and one or more broadcast receivers 122 coupled to a filter 124. The broadcast receivers 122 comprise one or more photodiodes that receive and convert optical broadcast signals from the optical fiber 12 through the filter 124. The demultiplexer 118 demultiplexes the optical narrowcast signals received over the optical fiber 12 and feeds the demultiplexed channels to the respective narrowcast receivers 120. The narrowcast receivers 120 comprise one or more photodiodes that receive and convert the optical narrowcast signals. Additionally, the node 13 comprises one or more combining modules 126, as described further below.

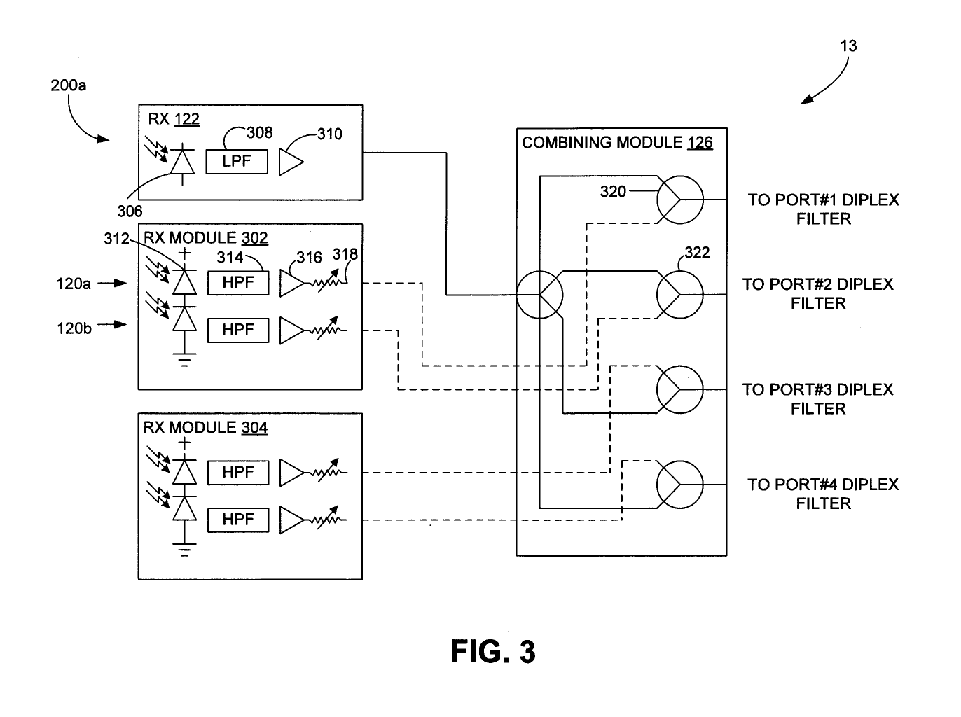

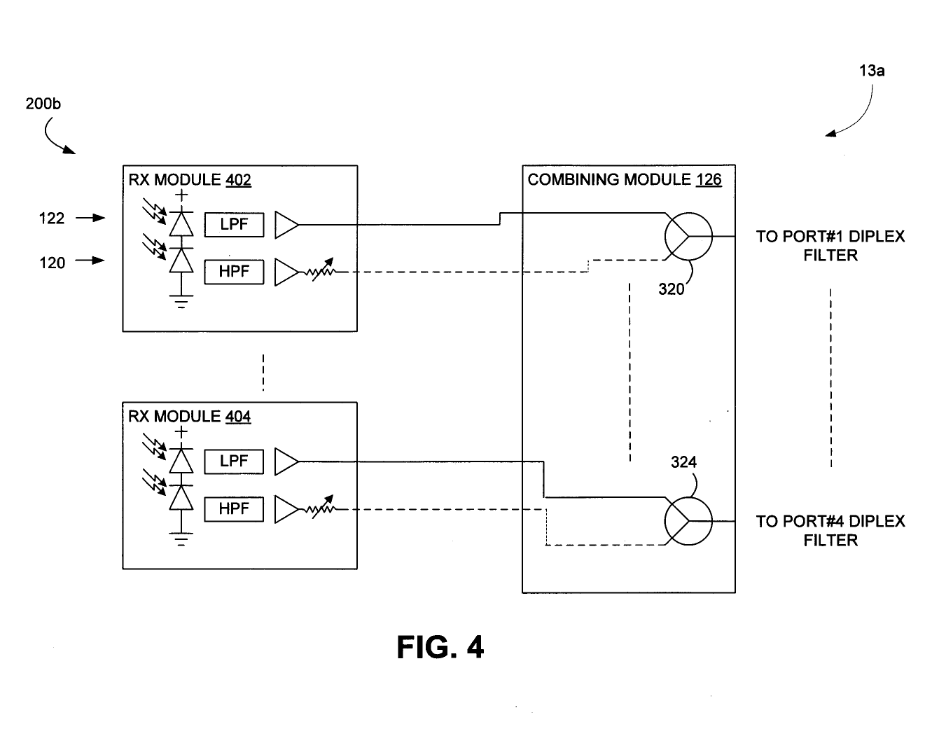

The node 13 comprises one or more configurations of receiver systems 200. For instance, one embodiment of a receiver system, denoted as 200a in FIG. 2, comprises two narrowcast receivers 120 logically paired (for combining at the combining module 126) with a broadcast receiver 122. In some embodiments, the logical pairing can be implemented on a single integrated circuit (e.g., application-specific integrated circuit or ASIC), though not necessarily limited to such an arrangement. Another embodiment, among others, comprises receiver system 200b, which comprises a 1:1 correspondence in logical pairing between narrowcast 120 and broadcast 122 receivers. For instance, the receiver system 200b comprises a single narrowcast receiver 120 paired (for combining at combining module 126) with a broadcast receiver 122. In some embodiments, the logical pairing may be implemented on a single integrated circuit, though not limited to such an arrangement. In some embodiments, other configurations for receiver systems 200 may be employed, such as differing quantities of receivers and/or logical pairings (integrated in a single chip or separate) in one or multiple nodes 13. The receiver systems 200 and corresponding cooperation with the combining module 126 are described below in association with FIGS. 3 and 4.

The architecture illustrated and described for the headend 11 and node 13 illustrates one embodiment, and one having ordinary skill in the art should understand in the context of this disclosure that other configurations of components and locations of such components are within the scope of the disclosure. For instance, although shown residing in the node 13, it should be understood by one having ordinary skill in the art that some of the node or headend components (or functionality of the same) may reside in other locations (e.g., hubs), and in some embodiments, such components may be distributed among different locations. For instance, components of the node 13 may physically reside outside of the node (e.g., the demultiplexer 118, multiplexer 116, and/or filter 124 may physically reside in a splice tray serving the node 13).

FIG. 3 is a schematic diagram of a node 13 comprising the receiver system 200a shown in FIG. 2. The receiver system 200a comprises a broadcast receiver 122 and one or more narrowcast receivers 120a and 120b (corresponding to narrowcast receivers 120 in FIG. 2) residing in modules 302 and 304 and logically paired with the broadcast receiver 122. The broadcast receiver 122 comprises well-known components, including, without limitation, a photodiode 306, filter (e.g., low pass filter or LPF) 308, and amplifier 310. Each narrowcast receiver 120a, 120b for each module 302 and 304 comprises, without limitation, a photodiode 312, filter 314 (e.g., high pass filter, or HPF), amplifier 316, and variable attenuator 318. Hence, separate and distinct photodiodes are used for narrowcast and broadcast signals. One having ordinary skill in the art should understand, in the context of this disclosure, that other configurations of broadcast and narrowcast receiver components, including different quantities of modules, may be employed in some embodiments. For instance, narrowcast and/or broadcast receivers may be implemented in some embodiments with matching circuitry that may or may not be included in a gain stage, an additional independent stage, filtering specific to the band (e.g., high pass, low pass, etc.), a third gain stage, and/or an attenuator to adjust the carrier level prior to RF combining, among other variations that should be understood by one having ordinary skill in the art in the context of the present disclosure.

As another example, in some embodiments, amplification and filtering may only be performed in the narrowcast receivers 120a and 120b (in lieu of amplification and filtering in the broadcast receiver 122). Explaining further, in such embodiments, if the link comprising the broadcast transmitter 102 and the broadcast receiver 122 is sufficiently linear with low noise, filtering before combining with the narrowcast receiver RF output may be unnecessary given the adequate stand-alone performance on the broadcast processing side. Since links are generally designed to assure adequate performance of broadcast channels with respect to gain and signal and noise levels, amplification and/or attentuation of the narrowcast link (e.g., the link comprising the narrowcast transmitter 106 and the narrowcast receiver 120) may be implemented (e.g., via amplifier 316 and attentuator 318, respectively) to adjust the level of the lower power narrowcast transmitter 106 to align with a specified system level (which primarily considers the broadcast transmitter performance level).

The receiver system 200a (and receiver system 200b explained below) and/or components thereof may be implemented in hardware, software, or a combination of both. For components implemented in hardware, any or a combination of the following technologies may be used, which are all well known in the art: a discrete logic circuit(s) having logic gates for implementing logic functions upon data signals, an ASIC having appropriate combinational logic gates, a programmable gate array(s) (PGA), a field programmable gate array (FPGA), etc.

Optical broadcast and narrowcast signals are converted at each photodiode 306 and 312, respectively, from the optical domain to the electrical domain (e.g., RF signal domain). The received signals are further processed (e.g., filtered, amplified, and/or attenuated) before being fed to the combining module 126, which comprises well-known components (e.g., directional couplers, RLC components, etc.). As shown in FIG. 3, signals from narrowcast receiver 120a of module 302 and broadcast receiver 122 are fed to the combining module 126 and combined at combiner 320, with the resultant combined signal fed to port#1 of a diplex filter (not shown). Likewise, signals from narrowcast receiver 120b of module 302 and broadcast receiver 122 are fed to the combining module 126 and combined at combiner 322, with the resultant combined signal fed to port #2 of a diplex filter (not shown). A similar arrangement is employed between module 304 and broadcast transmitter 122, and hence discussion of the same is omitted for brevity. Note that, although shown and described in the context of bi-directional communication through the use of a duplex filter, one having ordinary skill in the art should understand within the context of this disclosure that the principles described herein can similarly apply to uni-directional communication. Further, as is known, a diplex filter separates signals traveling in opposite directions (e.g., signals coming from the headend 11 to the subscriber terminal 16 and signals coming from the subscriber terminal 16 to the headend 11), and may be located in the subscriber terminal 16, at a home gateway, demarcation box, among other locations. One having ordinary skill in the art should understand in the context of the present disclosure that other switching mechanisms for enabling bi-directional communication may be employed in some embodiments.

Having provided an overview of an embodiment of the receiver system 200a, it is helpful at this point to explain some of the benefits of using separate photodiodes (e.g., photodiodes 306 and 312) for the narrowcast 120a, 120b and broadcast receivers 122 as shown in the receiver system 200a in FIG. 3, compared to a single photodiode for receiving both signals as is done conventionally. From the perspective of broadcast signal integrity, it has been found that the carrier-to-noise ratio (CNR) of a broadcast signal when combined with a narrowcast signal using the same photodiode can decline sharply as the optical input power of the narrowcast signal is increased. Ideally, for the narrowcast signal to have a negligible effect on the broadcast signal, the narrowcast signal should have a very low power relative to that of the broadcast signal (e.g., less than −10 dB). In such conventional systems, a typical implementation has a target 8 dB optical delta with a 1 dB penalty. However, from a practical standpoint, such a target is difficult to achieve due to the steepness by which the CNR can decline as a function of narrowcast input power. Additionally, adjustment in the field is limited by the common use of coarse adjustment attenuators. Thus, avoidance (e.g., by using separate photodiodes) of the inconvenience involved in achieving the target specification using a single photodiode for both the narrowcast and broadcast signals serves to protect the integrity of signals throughout the network.

From the perspective of the narrowcast signal, a quadrature amplitude modulation (QAM) signal is typically specified. For instance, one exemplary specification may require that the narrowcast channels (channels referring generally to defined frequency bands) at the end of the line (e.g., at the node 13) be at least 6 dB lower in channel power than broadcast channels. Some implementations may require more or less. That is, one having ordinary skill in the art should understand in the context of the present disclosure that 6 dB is described as an exemplary performance specification (e.g., for a 256 QAM system), and that other performance specifications are contemplated (e.g., 10 dB for 64 QAM, 3 dB, etc.) to be within the scope of the disclosure. Thus, processing for the narrowcast signal is disadvantaged by having to meet the required specification while hitting the receiver at 8-10 dB lower than the broadcast signal.

Explaining further, consider the typical relation between an optical receiver and the RF output corresponding to an input signal. The RF power of the channels is determined by the optical power incident on the receiver photodiode and the optical modulation index (OMI) of channels individually. However, the absolute power level of the RF output depends on the electrical components following the receiver photodiode. These electrical components have a limited capability (e.g., gain and noise performance) to alter those RF channel powers restricted by the photodiode output, and this in turn limits the maximum narrowcast channel count. More specifically, once the receive power and post RF amplification is configured for operation, the RF output for a particular information channel changes with the OMI. Conversely, once the OMI per channel and post RF amplification is configured for operation, the channel RF output changes with changes in carrier optical input power. This dynamic is valid per optical incident signal, applicable for one or more optical signals.

Thus, in a typical two-wavelength system where the optical delta is set (e.g., 8-10 dB), and where the specification requires a defined RF output ratio between channels carried by one wavelength and channels carried by another (e.g., 6 dB), the OMI becomes central to ensuring desired performance. From the perspective of the narrowcast signal for instance, such an operating environment limits the channel count that can be transmitted, because even though the RF output target is lower, the narrowcast signal also has to overcome lower input power. As explained above, the narrowcast signal can overcome this deficiency via an increase in OMI.

However, there is a finite limit to the maximum composite OMI that drives a laser before entering a non-linear modulation regime (overdriving). Overdriving the laser can exacerbate undesirable effects that appear as broadband and intermodulation noise penalties affecting the transmission system. Thus, single photodiode (i.e., for the broadcast and narrowcast signals) systems are typically limited to no more than 16 channels. Through the implementation of separate photodiodes for broadcast and narrowcast signals, and thus independent electronic components such as RF amplifiers, as shown in the receiver system 200a, the presented architecture enables compliance with end of line targets of RF power (e.g., 6 dB below the broadcast signal power) at a wider array of optical receive powers and OMI per channel values (i.e., more narrowcast channel capacity).

Additionally, filtering in the narrowcast receivers 120a, 120b assists in protecting the broadcast channels, since conversion is performed in the electrical domain. For instance, with filtering, noise (which is broadband and not restricted to the RF spectrum of the channel contents) may be reduced in the portion of the RF spectrum where the signals from the broadcast transmitter 102 reside. For instance, if the broadcast transmitter 102 has RF content from 50 to 550 MHz, and the narrowcast transmitter 106 has RF content only above 550 MHz, the noise content below 550 MHz may be reduced by filtering implemented in the narrowcast receivers 120a and 120b. Then, independent control of the amplitudes of the broadcast and narrowcast signals via amplifiers (e.g., amplifiers 310 and/or 316), attenuators 318, and filters (e.g., LPF 308 and/or HPF 314) may be used to ensure the signal levels are combined at an appropriate relative level for desired or specified system performance.

In some embodiments, an adjustable filter (e.g., in place of or in lieu of LPF 308 and/or HPF 314) may be used to alter the crossover frequency between the broadcast and narrowcast signal locations (e.g., component value choices) in the RF spectrum. Further, in some embodiments, filtering may be omitted (e.g. due to the restricted bandwidth needed on the narrowcast side). For instance, narrowcast transmitter and receiver pairs may be selected that produce lower noise than the broadcast link produces.

Additionally, the power used to transmit the narrowcast signals can be reduced in DBN systems 100 (e.g., from 8 dBm in conventional systems to 0-3 dBm in DBN systems). For instance, conventional systems attempt to maintain a lower RF level for the narrowcast signals when received at a subscriber terminal. To effect this lower RF level, one solution is to drive a broadcast transmitter at a lower RF drive. However, from a practical standpoint, similar narrowcast transmitters are combined with the broadcast transmitters in the optical domain at lower optical power levels to avoid noise degradation in the manner as described above. Increasing the RF drive levels generally compensates for the lower optical levels (e.g., to maintain the levels, the RF drive should increase 2 dB for every 1 dB decrease in optical power). By using separate photodiodes to receive the narrowcast and broadcast signals, as shown in the receiver system 200a of FIG. 3, optimization of the RF drive for the particular load required for the narrowcast signals and the desired bandwidth can be achieved. Further, as explained above, the RF level differences required at the subscriber terminals 16 can be achieved through independent control via filtering, amplification, and/or attenuation.

FIG. 4 is a schematic diagram of an alternate embodiment of a receiver system 200b for node 13, as shown in FIG. 2. The receiver system 200b comprises receiver modules 402 and 404, which are similarly constructed, though not necessarily so in some embodiments. Each receiver module 402 and 404 comprises a broadcast receiver 122 separate yet logically paired with narrowcast receiver 120. That is, though enclosed in the same module 402, separate and distinct photodiodes for the respective broadcast receiver 122 and narrowcast receiver 120 are used to receive and convert broadcast and narrowcast signals. In some embodiments, modules 402 and 404 are each embodied as separate integrated circuits, or in some embodiments, as a single module. In some embodiments, receiver system 200b is embodied as a single integrated circuit, though not limited to such an arrangement. The RF outputs (e.g., broadcast and narrowcast signals) of the broadcast receiver 122 and narrowcast receiver 120 for each module are fed (or in some embodiments, retrieved, such as through an intermediary processor) to the combining module 126, where the signals are combined at combiners 320 through 324, respectively, and passed through the respective diplex filter to one or more subscriber terminals 16 in a same or different region.

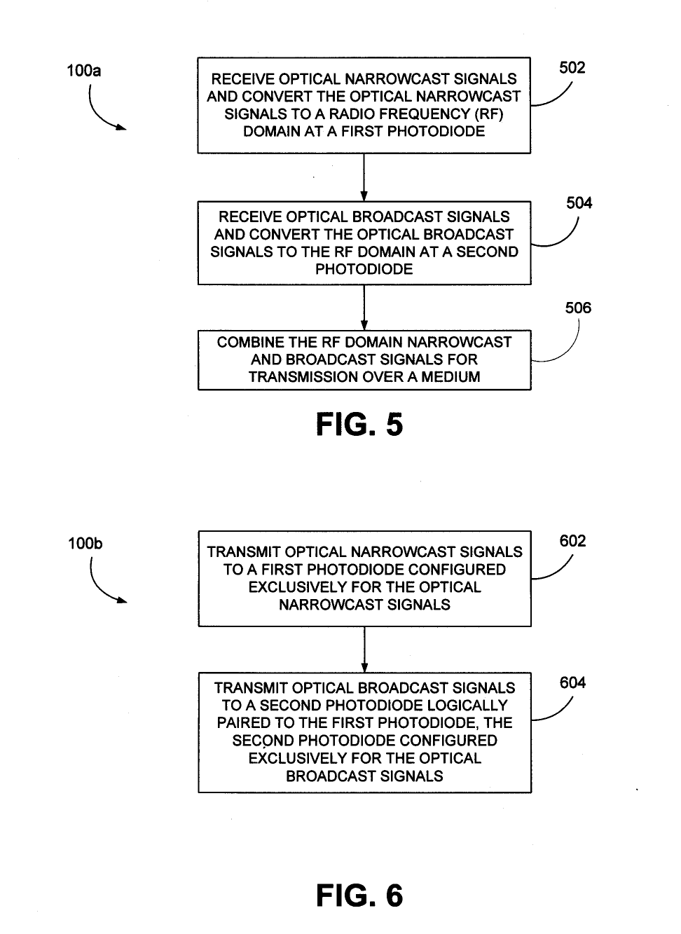

In view of the above description, it should be appreciated that one embodiment of a DBN method 100a (from a receive-side perspective) may comprise, as illustrated in FIG. 5, the steps of receiving optical narrowcast signals and converting the optical narrowcast signals to a radio frequency (RF) domain at a first photodiode (502), receiving optical broadcast signals and converting the optical broadcast signals to the RF domain at a second photodiode (504), and combining the RF domain narrowcast and broadcast signals for transmission over a medium (506).

Another method embodiment (from a transmit-side perspective), referenced as 100b and shown in FIG. 6, comprises the steps of transmitting optical narrowcast signals to a first photodiode configured exclusively for the optical narrowcast signals (602), and transmitting optical broadcast signals to a second photodiode logically paired to the first photodiode, the second photodiode configured exclusively for the optical broadcast signals (604).

It should be appreciated by one having ordinary skill in the art in the context of the present disclosure that the above described method embodiments are not limited to the architectures shown in FIGS. 3 and 4.

Any process descriptions or blocks in the flow diagrams of FIGS. 5 and 6 should be understood as representing modules, segments, or portions of code which include one or more executable instructions for implementing specific logical functions or steps in the process, and alternate implementations are included within the scope of the preferred embodiments of the disclosure in which functions may be executed out of order from that shown or discussed, including substantially concurrently or in reverse order, depending on the functionality involved, as would be understood by those reasonably skilled in the art of the present disclosure.

In addition, the scope of the various embodiments of the present disclosure includes embodying the functionality of the preferred embodiments in logic (whether residing in a transmitter, receiver, or transceiver) embodied in hardware or software-configured mediums.

It should be emphasized that the above-described embodiments of the present disclosure are merely possible examples of implementations, merely set forth for a clear understanding of the described principles. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A broadcast and narrowcast communications method, comprising the steps of:
receiving optical narrowcast signals and converting the optical narrowcast signals to a radio frequency (RF) domain at a first photodiode;
receiving optical broadcast signals and converting the optical broadcast signals to the radio frequency (RF) domain at a second photodiode; and
combining the RF domain narrowcast and broadcast signals for transmission over a medium.

2. The method of claim 1, further comprising the step of adjusting performance parameters of at least one of an amplifier, filter, and attenuator residing in a narrowcast receiver that includes the first photodiode to adjust a specified RF level at one or more subscriber terminals.

3. The method of claim 1, further comprising the step of adjusting performance parameters of at least one of an amplifier and a filter residing in a broadcast receiver that includes the second photodiode to adjust a specified RF level at one or more subscriber terminals.

4. The method of claim 1, wherein the steps of receiving the narrowcast optical signals and the broadcast optical signals comprise the steps of receiving the narrowcast optical signals along a first optical medium and the broadcast optical signals along a second optical medium.

5. The method of claim 1, wherein the steps of receiving the narrowcast optical signals and the broadcast optical signals comprise the steps of receiving the narrowcast optical signals and the broadcast optical signals along a shared optical medium.

6. The method of claim 1, wherein the step of receiving the narrowcast optical signals comprises the step of receiving the narrowcast optical signals over an optical medium coupled to a coarse wave division multiplexing (CWDM) laser.

7. A broadcast and narrowcast communications method, comprising the steps of:
transmitting optical narrowcast signals to a first photodiode configured exclusively for the optical narrowcast signals; and
transmitting optical broadcast signals to a second photodiode logically paired to the first photodiode, the second photodiode configured exclusively for the optical broadcast signals.

8. The method of claim 7, wherein the steps of transmitting the optical narrowcast signals and the optical broadcast signals comprise the steps of transmitting the optical narrowcast signals along a first optical medium and the optical broadcast signals along a second optical medium.

9. The method of claim 7, wherein the steps of transmitting the optical narrowcast signals and the optical broadcast signals comprise the steps of transmitting the optical narrowcast signals and the optical broadcast signals along a shared medium.

10. The method of claim 7, wherein the step of transmitting the optical narrowcast signals comprises the step of transmitting from a coarse wave division multiplexing (CWDM) laser.

11. A dual broadcast and narrowcast communication system, comprising:
a first photodiode configured to receive optical narrowcast signals and convert the optical narrowcast signals to a radio frequency (RF) domain;
a second photodiode configured to receive optical broadcast signals and convert the optical broadcast signals to the radio frequency (RF) domain; and
a combining module configured to combine the RF domain narrowcast and broadcast signals for transmission over a medium.

12. The system of claim 11, further comprising at least one of an amplifier, filter, and attenuator residing in a narrowcast receiver that includes the first photodiode, the at least one of the amplifier, filter, and attenuator configured for adjustment of performance parameters to adjust a specified RF level at one or more subscriber terminals.

13. The system of claim 11, further comprising at least one of an amplifier and a filter residing in a broadcast receiver that includes the second photodiode, the at least one of an amplifier and a filter configured for adjustment of performance parameters to adjust a specified RF level at one or more subscriber terminals.

14. The system of claim 11, further comprising:
a first transmitter configured to transmit the optical narrowcast signals to the first photodiode; and
a second transmitter configured to transmit the optical broadcast signals to the second photodiode.

15. The system of claim 11, wherein the first transmitter comprises a coarse wave division multiplexing (CWDM) laser.
